(19) United States
(12) Patent Application Publication
(10) Pub. No.: US 2018/0034155 A1
(43) Pub. Date: Feb. 1, 2018

(54) ANTENNA DEVICE, COMMUNICATION APPARATUS, AND METHOD FOR PRODUCING ANTENNA DEVICE

(71) Applicant: Takashi OTSUKI, Hyogo (JP)

(72) Inventor: Takashi OTSUKI, Hyogo (JP)

(21) Appl. No.: 15/647,333

(22) Filed: Jul. 12, 2017

(30) Foreign Application Priority Data
Jul. 26, 2016 (JP) 2016-146158

(51) Int. Cl. H01Q 7/08; H01Q 1/40; H01Q 1/38; H01Q 1/27

(52) U.S. Cl. CPC H01Q 7/08; H01Q 1/273; H01Q 1/40; H01Q 1/38

(57) ABSTRACT

An antenna device includes a magnetic body and a coil of conducting wire wound around the magnetic body. The antenna device has an inductance held within a predetermined range by adjustment of certain predetermined parameters based on a magnetic permeability of the magnetic body. The predetermined parameters determine the inductance and relate to at least one of the magnetic body and the conducting wire.

### CROSS-REFERENCE TO RELATED APPLICATION

This patent application is based on and claims priority pursuant to 35 U.S.C. § 119(a) to Japanese Patent Application No. 2016-146158, filed on Jul. 26, 2016, in the Japan Patent Office, the entire disclosure of which is hereby incorporated by reference herein.

### BACKGROUND

### Technical Field

Embodiments of the present disclosure generally relate to an antenna device, a communication apparatus, and a method for producing an antenna device.

### Related Art

Portable information terminals such as smartphones and wearable terminals employ a magnetic-coupling-type communication system typified by near field communication (NFC). To implement the functions of the communication system, the portable information terminals are equipped with an antenna device. As such portable information terminals get lighter, thinner, shorter, and smaller while having multiple capabilities, there is an increased demand for a smaller and thinner antenna device to be installed in the portable information terminals.

For example, such an antenna device includes a magnetic core and a coil of linear conductor wound around the magnetic core.

### SUMMARY

In one embodiment of the present disclosure, a novel antenna device is described that includes a magnetic body and a coil of conducting wire wound around the magnetic body. The antenna device has an inductance held within a predetermined range by adjustment of certain predetermined parameters based on a magnetic permeability of the magnetic body. The predetermined parameters determine the inductance and relate to at least one of the magnetic body and the conducting wire.

Also described are a novel communication apparatus and a novel method for producing an antenna device.

### BRIEF DESCRIPTION OF THE DRAWINGS

A more complete appreciation of the disclosure and many of the attendant advantages thereof will be more readily obtained as the same becomes better understood by reference to the following detailed description of embodiments when considered in connection with the accompanying drawings, wherein:

FIG. 1A is a front view of an antenna device according to an embodiment of the present disclosure;

FIG. 1B is a plan view of the antenna device of FIG. 1A;

FIG. 1C is a side view of the antenna device of FIG. 1A;

FIG. 2 is a diagram of a magnetic body and a measuring device for measuring magnetic permeability of the magnetic body;

FIG. 3 is a diagram illustrating how to adjust inductance L using the width of the coil of a conducting wire;

FIG. 4A is a view of the antenna device of FIG. 1A before adjustment of the inductance L using the Nagaoka coefficient;

FIG. 4B is a view of the antenna device of FIG. 1A with a magnetic body of the antenna device shortened to adjust the inductance L using the Nagaoka coefficient;

FIG. 4C is a view of the antenna device of FIG. 1A with the magnetic body of the antenna device further shortened to adjust the inductance L using the Nagaoka coefficient;

FIG. 5 is a diagram illustrating how to adjust the inductance L using the diameter of the conducting wire; and

FIG. 6 is a graph of simulation results illustrating changes in the inductance L with changes in diameter of the conducting wire.

The accompanying drawings are intended to depict embodiments of the present disclosure and should not be interpreted to limit the scope thereof. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve similar results.

Although the embodiments are described with technical limitations with reference to the attached drawings, such description is not intended to limit the scope of the disclosure and not all of the components or elements described in the embodiments of the present disclosure are indispensable to the present disclosure.

In a later-described comparative example, embodiment, and exemplary variation, for the sake of simplicity like reference numerals are given to identical or corresponding constituent elements such as parts and materials having the same functions, and redundant descriptions thereof are omitted unless otherwise required.

As used herein, the singular forms “a”, “an”, and “the” are intended to include the plural forms as well, unless the context clearly indicates otherwise.

Referring now to the drawings, a description is given below of an antenna device, a communication apparatus, and a method for producing an antenna device according to embodiments of the present disclosure.

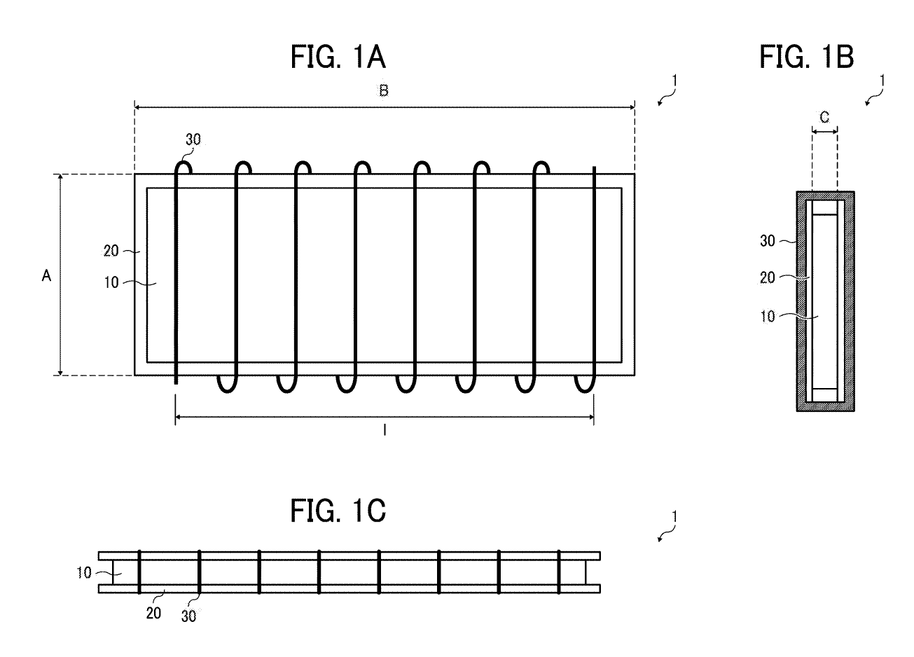

Initially with reference to FIGS. 1A through 1C, a description is given of an antenna device 1 according to an embodiment of the present disclosure.

FIG. 1A is a front view of the antenna device 1. FIG. 1B is a plan view of the antenna device 1. FIG. 1C is a side view of the antenna device 1. In the present embodiment, the antenna device 1 is a magnetic-coupling-type antenna device.

A magnetic-coupling-type antenna device is different from a resonance-type antenna device. The resonance-type antenna device causes vibration in sympathy with electromagnetic waves having a particular frequency, thereby sending or receiving the electromagnetic waves. By contrast, the magnetic-coupling-type antenna device is magnetically coupled to a magnetic flux generated by another antenna device as a communication partner, thereby communicating with the communication partner. The effective communication range of the resonance-type antenna device is from several meters to several kilometers or greater. By contrast, the effective communication range of the magnetic-coupling-type antenna device is approximately one meter or less, for example.

That is, the magnetic-coupling-type antenna device 1 is an antenna device for short-distance communication or nearby communication. The antenna device 1 of FIGS. 1A through 1C sends or receives signals having a frequency of, e.g., 13.56 MHz.

Generally, self-inductance L of antenna devices is physically determined by, e.g., the magnetic permeability of a magnetic body, the size of the magnetic body, and parameters pertaining to how the conducting wire is wound (e.g., the number of turns, diameter, pitch, width of the coil of the conducting wire).

With respect to how the conducting wire is wound, the accuracy of the parameters is controllable. By contrast, with respect to the magnetic body, the magnetic permeability is hardly controlled due to a production process of the magnetic body. The magnetic permeability varies for each production lot (i.e., a given number of magnetic bodies), in each of the production lots, between sheets (i.e., sheets of a plurality of magnetic bodies), and the like. As a consequence, the magnetic permeability may vary for each magnetic body provided in one antenna device. Such variation in the magnetic permeability of the magnetic body may lead to variation in the self-inductance L of the antenna device, which is undesirable.

In addition, since resonance frequency of an antenna is determined by the capacitance C and inductance L of the antenna device, variation in the inductance L leads to variation in the resonance frequency. In communication systems where the resonance frequency is determined, variation in the resonance frequency degrades communication performance and may interrupt communication.

In order to keep the resonance frequency stable, the capacitance C is adjusted to obtain a desired frequency while the inductance L remains unchanged. For example, a first approach involves calculating a necessary capacitance C from a resonance frequency formula when the inductance L is measured. A capacitor corresponding to the capacitance C thus calculated is selected and incorporated into a circuit. A second approach involves adjusting the capacitance C. Specifically, a variable capacitor is incorporated into a circuit in advance. While the resonance frequency is observed with, e.g., a spectrum analyzer, the variable capacitor adjusts the capacitance C to obtain a desired frequency.

For example, some antenna devices may be provided with a metal board of a size identical to a size of the antenna devices. By changing the size of the metal board, the inductance L may be adjusted.

However, as described above, the first approach involves measurement of the inductance L for each antenna device and incorporation of a capacitor for adjustment. As a consequence, steps in the production process increase. On the other hand, the second approach involves operators to observe a measuring device and perform an adjustment to adjust and obtain a desired resonance frequency in the production process. That is, the operators must perform additional tasks. Alternatively, an increased number of operators may be needed to perform such tasks. In addition, a measuring device needs to be installed, thereby further complicating the production process. Relatedly, the antenna devices with the metal board described above may include complicated processing tasks, thereby further complicating the production process.

According to embodiments of the present disclosure, the antenna device 1 reduces steps in the production process and the number of parts to be installed. In addition, variation in the inductance L is reduced.

Referring back to FIGS. 1A through 1C, the antenna device 1 includes a magnetic body 10, an insulating material 20, and a coil 30.

The magnetic body 10 is a rectangle sintering ferrite having a length A of 11 mm, a length B of 14 mm, and a thickness C of 0.2 mm, for example. It is to be noted that the length A is a length of the magnetic body 10 in a short direction thereof. The length B is a length of the magnetic body 10 in a longitudinal direction thereof. Hereinafter, the length A may be referred to as a short-direction length A. Similarly, the length B may be referred to as a longitudinal-direction length B. The size of the magnetic body 10 described above is an example size. Alternatively, the magnetic body 10 may be a cube having a short-direction length A of 5 mm, a longitudinal-direction length B of 5 mm, and a thickness C of 5 mm, for example.

The magnetic body 10 is shaped like a plate or a cube. However, the shape of the magnetic body 10 can be determined as appropriate for, e.g., the size and the shape of a space in which the antenna device 1 is installed, and for a communication range required taking into account the characteristics of the antenna device 1. The magnetic body 10 is not limited to the sintering ferrite. Alternatively, the magnetic body 10 may be made of iron, nickel, manganese, zinc, or an alloy of iron, nickel, manganese, and zinc, provided that the magnetic body 10 is made of a ferromagnetic material. Alternatively, the magnetic body 10 may be a flexible sheet capable of being bent. The magnetic body 10 may have a flexible shape changeable to conform to the shape of a housing that accommodates the magnetic body 10, for example.

The insulating material 20 sandwiches the magnetic body 10, thereby covering the magnetic body 10. The insulating material 20 is, e.g., polyethylene terephthalate (PET). Alternatively, the insulating material 20 may be a heat-resistant resin such as polyimide.

The coil 30 is a coil of conducting wire wound around the magnetic body 10 a plurality of times along the short direction of the magnetic body 10. In FIGS. 1A through 1C, the coil 30 is wound around the magnetic body 10 at a predetermined pitch of the conducting wire, thereby holding a predetermined interval between adjacent portions of the conducting wire. Accordingly, the conducting wire is wound around the entire magnetic body 10, thereby generating a magnetic flux. The coil 30 has opposed ends coupled to a communicator of an apparatus (e.g., communication apparatus) that performs communication by use of the antenna device 1. The communicator communicates with an external device.

As the conducting wire of the coil 30, a copper wire may be used, for example. The conducting wire of the coil 30 has a thickness (i.e., diameter) of, e.g., 50 μm. The conducting wire of the coil 30 is wound around the magnetic body 10, e.g., twenty times. The conducting wire used as the coil 30 has an enamel-coated surface. With the enamel-coated surface, the conducting wire of the coil 30 has a thickness (i.e., diameter) of, e.g., 69 μm.

The thickness, the number of turns, the winding way, and the like of the conducting wire of the coil 30 are described as examples, and may be determined as appropriate for, e.g., the application purposes of the antenna device 1. The antenna device 1 of the present embodiment is described that includes the conducting wire of the coil 30 wound around the magnetic body 10 in the short direction of the magnetic body 10.

Now, a description is given of adjustment of an inductance L in the antenna device 1 configured as described above according to the present embodiment. The inductance L of the antenna device 1 is obtained by Equation 1 as below:

$$L = \frac{K \cdot μ \cdot S \cdot {N}^{2}}{l} \qquad ( 1 )$$

wherein “L” represents an inductance (H), “K” represents the Nagaoka coefficient (i.e., demagnetizing factor), “μ” represents a magnetic permeability (H/m), “S” represents a cross-sectional area (m²) of the coil 30, “N” represents a number of turns of the conducting wire, and “1” represents a width of the coil of the conducting wire. In other words, “1” represents a length (m) of the coil 30 in the longitudinal direction of the magnetic body 10.

The inductance L of the antenna device 1 is determined by values of certain parameters, that is, the parameters described in Equation 1 above. “μ” corresponds to the magnetic permeability of the magnetic body 10. The magnetic permeability μ is a parameter that most varies during production of the antenna device 1. On the other hand, parameters other than the magnetic permeability μ maintain physical stability and are adjustable in a production process of the antenna device 1.

Accordingly, in the antenna device 1 of the present embodiment, the parameters other than the magnetic permeability μ are adjusted based on a value of the magnetic permeability μ. The parameters other than the magnetic permeability μ include at least one of the magnetic body 10 and the conducting wire of the coil 30. Such adjustment of the parameters other than the magnetic permeability μ based on the value of the magnetic permeability μ keeps the inductance L stable, thereby holding the inductance L within a predetermined range.

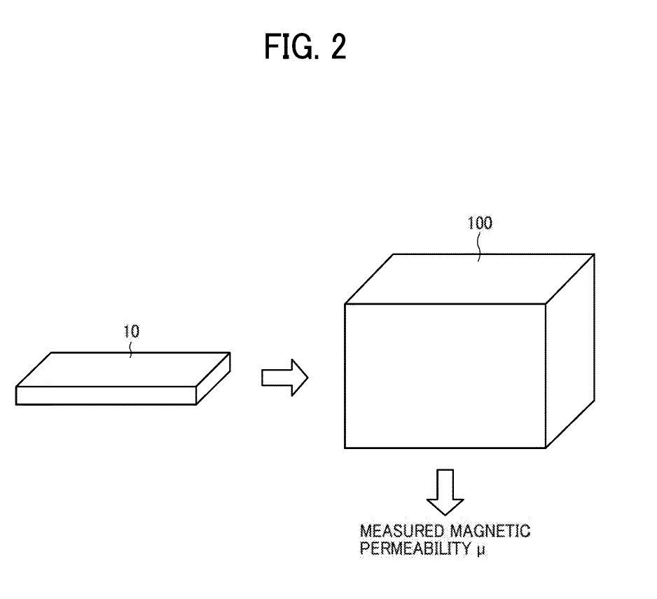

Referring now to FIG. 2, a description is given of measurement of the magnetic permeability μ of the magnetic body 10. To produce the antenna device 1, firstly, the magnetic permeability μ of the magnetic body 10 of the antenna device 1 is measured.

FIG. 2 is a diagram of the magnetic body 10 and a measuring device 100 for measuring, e.g., the magnetic permeability μ of the magnetic body 10.

As illustrated in FIG. 2, the measuring device 100 measures the magnetic permeability μ of the magnetic body 10. The measuring device 100 is an example of a measuring device that measures the magnetic permeability μ of the magnetic body 10. Based on the magnetic permeability μ thus measured, an adjustment parameter is determined to hold the inductance L within the predetermined range. In the production process of the antenna device 1, a physical quantity of the adjustment parameter thus determined is adjusted. A detailed description of the adjustment parameter is deferred.

It is to be noted that, in the configuration described above, the measuring device 100 measures the magnetic permeability μ of the magnetic body 10. However, the measuring device 100 is not limited to measure the magnetic permeability μ of the magnetic body 10. Alternatively, for example, the measuring device 100 may measure the inductance L to calculate the magnetic permeability μ by use of Equation 1. In such a case, the parameters other than the magnetic permeability μ on a right side of Equation 1 are fixed. The inductance L is held within the predetermined range based on the magnetic permeability μ thus calculated. Alternatively, for example, the measuring device 100 may measure a quality factor or Q factor of the coil 30 to calculate the magnetic permeability μ. In such a case, the inductance L is held within the predetermined range based on the magnetic permeability μ thus calculated. In the present embodiment described below, the measuring device 100 measures the magnetic permeability μ of the magnetic body 10.

Now, a detailed description is given of some examples of the adjustment parameter.

The adjustment parameter is, e.g., the width of the coil of the conducting wire. Adjustment of the width of the coil of the conducting wire keeps the inductance L of the antenna device 1 stable.

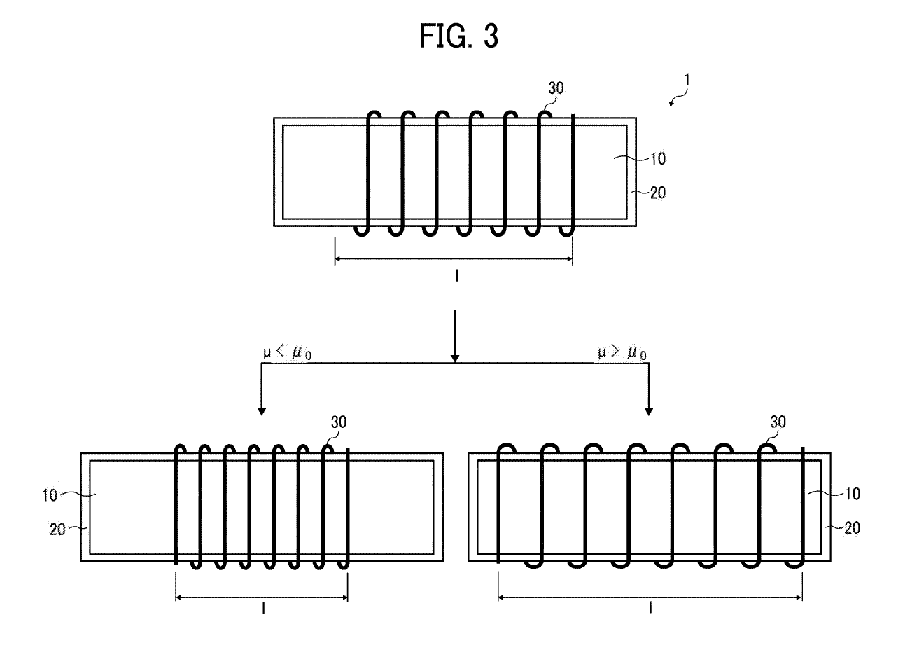

FIG. 3 is a diagram illustrating how to adjust the inductance L using the width of the coil of the conducting wire.

In FIG. 3, “1” represents the width of the coil of the conducting wire. Hereinafter, the width of the coil of the conducting wire may be referred to as the width 1 of the coil of the conducting wire. As illustrated in FIG. 3, the width 1 of the coil of the conducting wire is a length of the coil 30 in the longitudinal direction of the magnetic body 10. The width 1 of the coil of the conducting wire is a denominator on the right side of Equation 1 above.

In the present embodiment, the antenna device 1 of FIGS. 1A through 1C is a basic antenna device produced by winding a conducting wire having a given diameter around a magnetic body of a given size with a given number of turns and with a given width 1 of the coil. An ideal inductance L is determined. An allowance including the inductance L thus determined and a predetermined error is a predetermined range of a target inductance L. Specifically, the ideal inductance L is, e.g., 1 μH. The predetermined error is, e.g., ±3%. In this case, the predetermined range of the inductance L is from 0.97 μH to 1.03 μH. When the inductance L is within the predetermined range, the magnetic permeability μ₀ is obtained. By the ideal inductance L and desired communication characteristics relative to the antenna device 1, values of the basic parameters (i.e., K: Nagaoka coefficient, S: the cross-sectional area of the coil 30, N: the number of turns of the conducting wire, and l: the width of the coil of the conducting wire (coil length)) are determined.

Referring back to FIG. 3, if the magnetic permeability μ measured by the measuring device 100 is smaller than the magnetic permeability μ₀ (i.e., μ<μ₀), a numerator on the right side of Equation 1 decreases. In this case, the antenna device 1 has an inductance L smaller than the inductance L within the predetermined range.

To increase the inductance L into the predetermined range, the width 1 of the coil of the conducting wire is reduced so as to shorten a coil length without changing the number of turns of the conducting wire. That is, reduction in the width 1 of the coil of the conducting wire decreases the denominator on the right side of Equation 1. As a consequence, the inductance L increases.

By contrast, if the magnetic permeability μ measured by the measuring device 100 is greater than the magnetic permeability μ₀ (i.e., μ>μ₀), the numerator on the right side of Equation 1 increases. In this case, the antenna device 1 has an inductance L greater than the inductance L within the predetermined range.

To decrease the inductance L into the predetermined range, the width 1 of the coil of the conducting wire is increased so as to lengthen the coil length without changing the number of turns of the conducting wire. That is, an increase in the width 1 of the coil of the conducting wire increases the denominator on the right side of Equation 1. As a consequence, the inductance L decreases.

Now, a description is given of a method for producing the antenna device 1 in a case in which the inductance L is adjusted by changing the width 1 of the coil of the conducting wire as described above.

To produce the antenna device 1, firstly, the magnetic permeability μ of the magnetic body 10 is measured as described above. Then, the magnetic permeability μ thus measured is compared to the magnetic permeability μ₀ obtained when the inductance L is an ideal inductance L, that is, when the inductance L is within the predetermined range. Based on the comparison, the width 1 of the coil of the conducting wire is adjusted to produce the antenna device 1.

Thus, among the parameters that determine the inductance L in the antenna device 1, the width 1 of the coil of the conducting wire wound around the magnetic body 10 is reduced or greater based on the magnetic permeability μ. Accordingly, the inductance L of the antenna device 1 is adjusted to be within the predetermined range, thereby reducing variation in the inductance L.

Now, a description is given of the Nagaoka coefficient as another adjustment parameter.

Adjustment of the Nagaoka coefficient keeps the inductance L of the antenna device 1 stable.

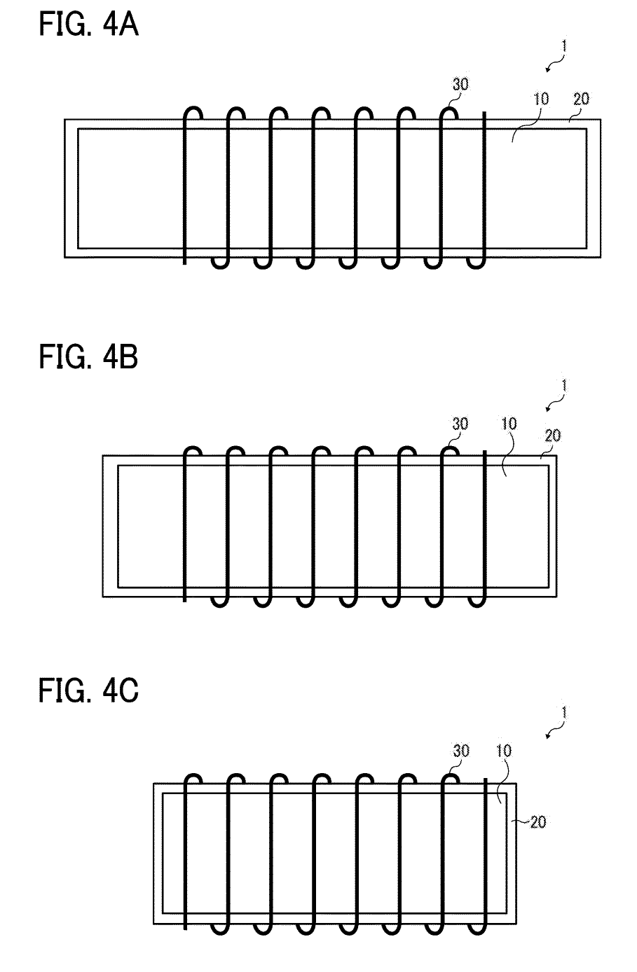

FIG. 4A through 4C illustrates how to adjust the inductance L using the Nagaoka coefficient. Specifically, FIG. 4A is a view of the antenna device 1 before adjustment of the inductance L using the Nagaoka coefficient. FIG. 4B is a view of the antenna device 1 with the magnetic body 10 shortened to adjust the inductance L using the Nagaoka coefficient. FIG. 4C is a view of the antenna device 1 with the magnetic body 10 further shortened to adjust the inductance L using the Nagaoka coefficient.

The Nagaoka coefficient is a numerator on the right side of Equation 1 above. Hereinafter, the Nagaoka coefficient may be referred to as the Nagaoka coefficient K. The Nagaoka coefficient K satisfies a relation of 0<K≦1. An ideal Nagaoka coefficient K is 1.

If the magnetic permeability μ measured by the measuring device 100 is greater than the magnetic permeability μ₀ (i.e., μ>μ₀), the numerator on the right side of Equation 1 increases. In this case, the antenna device 1 has an inductance L greater than the inductance L within the predetermined range.

To decrease the inductance L into the predetermined range, as illustrated in FIG. 4B, the length of the magnetic body 10 in the longitudinal direction thereof (i.e., longitudinal-direction length B of FIG. 1A) is reduced, while the conducting wire of the coil 30 remains unchanged. That is, shortening the magnetic body 10 in the longitudinal direction thereof decreases the Nagaoka coefficient K and the numerator on the right side of Equation 1. As a consequence, the inductance L decreases.

If the magnetic permeability μ measured by the measuring device 100 is further greater than the magnetic permeability μ₀ (i.e., μ>μ₀), the numerator on the right side of Equation 1 further increases. In this case, the antenna device 1 has an inductance L further greater than the inductance L within the predetermined range.

To decrease the inductance L into the predetermined range, as illustrated in FIG. 4C, the length of the magnetic body 10 in the longitudinal direction thereof (i.e., longitudinal-direction length B of FIG. 1A) is further reduced, while the conducting wire of the coil 30 remains unchanged. That is, further shortening the magnetic body 10 in the longitudinal direction thereof further decreases the Nagaoka coefficient K and the numerator on the right side of Equation 1. As a consequence, the inductance L decreases.

Now, a description is given of a method for producing the antenna device 1 in a case in which the inductance L is adjusted with the Nagaoka coefficient K described above.

To produce the antenna device 1, firstly, the magnetic permeability μ of the magnetic body 10 is measured as described above. Then, the magnetic permeability μ thus measured is compared to the magnetic permeability μ₀ obtained when the inductance L is an ideal inductance L, that is, when the inductance L is within the predetermined range. Based on the comparison, the length of the magnetic body 10 is adjusted in the longitudinal direction thereof to produce the antenna device 1.

Thus, among the parameters that determine the inductance L in the antenna device 1, the magnetic body 10 is shortened in the longitudinal direction thereof, based on the magnetic permeability μ. In other words, a length of the magnetic body 10 in a first direction intersecting a second direction in which the conducting wire is wound is adjusted, based on the magnetic permeability μ. Accordingly, the inductance L of the antenna device 1 is adjusted to be within the predetermined range, thereby reducing variation in the inductance L. Although the magnetic body 10 is shortened in the longitudinal direction thereof as described above, the magnetic body 10 is hardly lengthened in the longitudinal direction thereof. Therefore, if the magnetic permeability μ measured by the measuring device 100 is smaller than the magnetic permeability μ₀, the inductance L is hardly adjusted with the Nagaoka coefficient K.

Now, a description is given of the diameter of the conducting wire as yet another adjustment parameter.

Adjustment of the diameter of the conducting wire keeps the inductance L of the antenna device 1 stable.

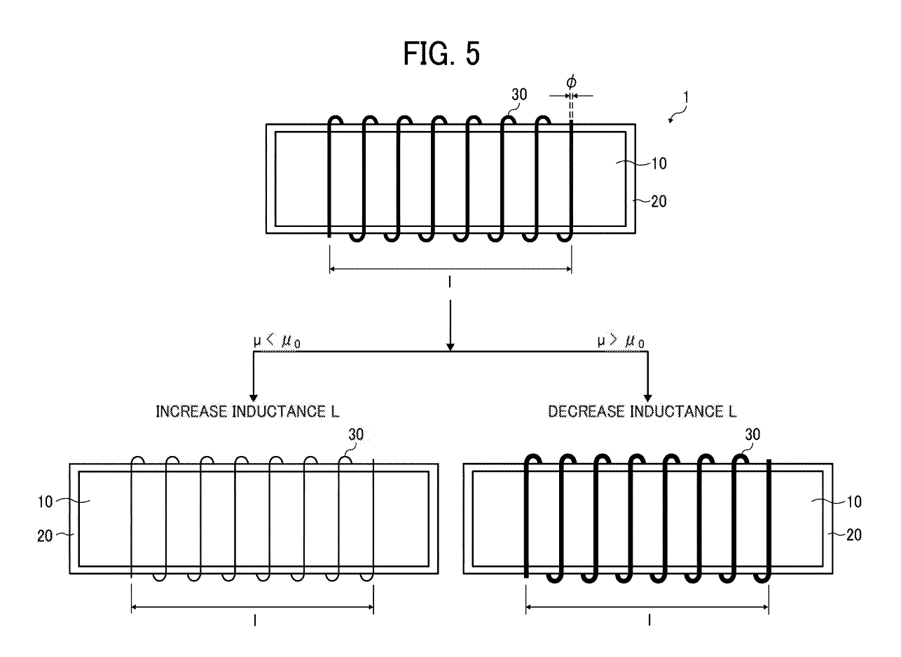

FIG. 5 is a diagram illustrating how to adjust the inductance L using the diameter of the conducting wire.

In FIG. 5, “φ” represents the diameter of the conducting wire. Hereinafter, the diameter of the conducting wire may be referred to as the diameter φ of the conducting wire. The diameter φ of the conducting wire is one of the parameters that determine the inductance L.

If the magnetic permeability μ measured by the measuring device 100 is smaller than the magnetic permeability μ₀ (i.e., μ<μ₀), the numerator on the right side of Equation 1 decreases. In this case, the antenna device 1 has an inductance L smaller than the inductance L within the predetermined range.

To increase the inductance L into the predetermined range, the diameter φ of the conducting wire is reduced without changing the number of turns of the conducting wire or the width of the coil of the conducting wire. In other words, the conducting wire is made thinner so that the inductance L is within the predetermined range.

Now, a description is given of a relation between the diameter φ of the conducting wire and the inductance L.

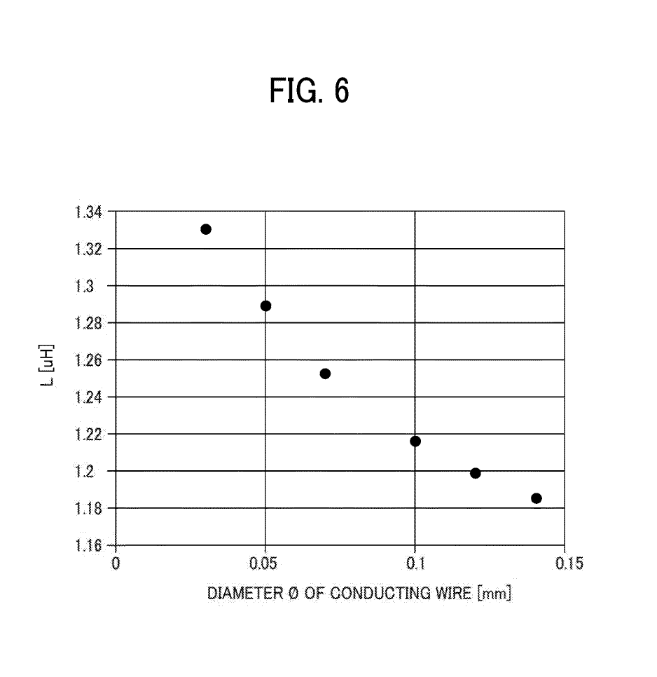

FIG. 6 is a graph of simulation results illustrating changes in the inductance L with changes in the diameter φ of the conducting wire.

FIG. 6 illustrates changes in the inductance L as the diameter φ of the conducting wire is changed from about 0.03 mm (i.e., 30 μm) to about 0.14 mm (i.e., 140 μm). It is to be noted that the parameters other than the diameter φ of the conducting wire remain unchanged. As is apparent from FIG. 6, a smaller diameter φ of the conducting wire increases the inductance L. By contrast, a greater diameter φ of the conducting wire decreases the inductance L.

Referring back to FIG. 5, reduction in the diameter φ of the conducting wire increases the inductance L, based on the simulation results of FIG. 6.

By contrast, if the magnetic permeability μ measured by the measuring device 100 is greater than the magnetic permeability μ₀ (i.e., μ>μ₀), the numerator on the right side of Equation 1 increases. In this case, the antenna device 1 has an inductance L greater than the inductance L within the predetermined range.

To decrease the inductance L into the predetermined range, the diameter φ of the conducting wire is increased without changing the number of turns of the conducting wire or the width of the coil of the conducting wire. In other words, the conducting wire is made thicker so that the inductance L is within the predetermined range. In short, an increase in the diameter φ of the conducting wire increases the inductance L, based on the simulation results of FIG. 6.

Now, a description is given of a method for producing the antenna device 1 in a case in which the inductance L is adjusted by changing the diameter φ of the conducting wire as described above.

To produce the antenna device 1, firstly, the magnetic permeability μ of the magnetic body 10 is measured as described above. Then, the magnetic permeability μ thus measured is compared to the magnetic permeability μ₀ obtained when the inductance L is an ideal inductance L, that is, when the inductance L is within the predetermined range. Based on the comparison, the diameter φ of the conducting wire is adjusted to produce the antenna device 1.

Thus, among the parameters that determine the inductance L in the antenna device 1, the diameter φ of the conducting wire is reduced or greater based on the magnetic permeability μ. Accordingly, the inductance L of the antenna device 1 is adjusted to be within the predetermined range, thereby reducing variation in the inductance L.

Alternatively, among the parameters that determine the inductance L, the pitch of the conducting wire may be adjusted based on the magnetic permeability μ to adjust the inductance L of the antenna device 1 to be within the predetermined range. In such a case, similar to the adjustment described above, the inductance L of the antenna device 1 is adjusted to be within the predetermined range, thereby reducing variation in the inductance L.

Thus, the antenna device 1 of the present embodiment includes the coil 30 of conducting wire wound around the magnetic body 10. Based on the magnetic permeability μ of the magnetic body 10, the adjustment parameter is determined to hold the inductance L within the predetermined range. In the production process of the antenna device 1, the adjustment parameter thus determined is adjusted. Accordingly, the antenna device 1 is produced having the inductance L within the predetermined range.

Examples of the adjustment parameter include, e.g., the width 1 of the coil of the conducting wire, the Nagaoka coefficient K, the diameter φ of the conducting wire, and the pitch of the conducting wire, in other word, the interval between the adjacent portions of the conducting wire. Thus, according to the embodiments, steps in the production process and the number of parts to be installed are reduced. In addition, variation in the inductance L is reduced.

Although the present disclosure makes reference to specific embodiments, it is to be noted that the present disclosure is not limited to the details of the embodiments described above and various modifications and enhancements are possible without departing from the scope of the present disclosure. It is therefore to be understood that the present disclosure may be practiced otherwise than as specifically described herein. For example, elements and/or features of different embodiments may be combined with each other and/or substituted for each other within the scope of the present disclosure. The number of constituent elements and their locations, shapes, and so forth are not limited to any of the structure for performing the methodology illustrated in the drawings.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate allay) and conventional circuit components arranged to perform the recited functions.

Any one of the above-described operations may be performed in various other ways, for example, in an order different from the one described above.

Further, any of the above-described devices or units can be implemented as a hardware apparatus, such as a special-purpose circuit or device, or as a hardware/software combination, such as a processor executing a software program.

Further, as described above, any one of the above-described and other methods of the present disclosure may be embodied in the form of a computer program stored in any kind of storage medium. Examples of storage mediums include, but are not limited to, flexible disk, hard disk, optical discs, magneto-optical discs, magnetic tapes, nonvolatile memory cards, read only memory (ROM), etc.

Alternatively, any one of the above-described and other methods of the present disclosure may be implemented by an application specific integrated circuit (ASIC), prepared by interconnecting an appropriate network of conventional component circuits or by a combination thereof with one or more conventional general purpose microprocessors and/or signal processors programmed accordingly.

What is claimed is:

1. An antenna device comprising:
a magnetic body; and
a coil of conducting wire wound around the magnetic body,
the antenna device having an inductance held within a predetermined range by adjustment of certain predetermined parameters based on a magnetic permeability of the magnetic body,
the predetermined parameters determining the inductance and relating to at least one of the magnetic body and the conducting wire.

2. The antenna device according to claim 1, wherein the predetermined parameters include a width of the coil around the magnetic body,
wherein adjustment of the width of the coil around the magnetic body based on the magnetic permeability holds the inductance of the antenna device within the predetermined range.

3. The antenna device according to claim 1, wherein the predetermined parameters include a length of the magnetic body in a first direction intersecting a second direction in which the conducting wire is wound,
wherein adjustment of the length of the magnetic body in the first direction based on the magnetic permeability holds the inductance within the predetermined range.

4. The antenna device according to claim 1, wherein the predetermined parameters include a diameter of the conducting wire,
wherein adjustment of the diameter of the conducting wire based on the magnetic permeability holds the inductance within the predetermined range.

5. The antenna device according to claim 1, wherein the predetermined parameters include a pitch of the conducting wire,
wherein adjustment of the pitch of the conducting wire based on the magnetic permeability holds the inductance within the predetermined range.

6. The antenna device according to claim 1, the magnetic permeability of the magnetic body is measured by a measuring device.

7. The antenna device according to claim 1, wherein the inductance is measured by a measuring device to calculate the magnetic permeability, and
wherein the inductance is held within the predetermined range based on the magnetic permeability thus calculated.

8. The antenna device according to claim 1, wherein a quality factor of the coil is measured by a measuring device to calculate the magnetic permeability, and
wherein the inductance is held within the predetermined range based on the magnetic permeability thus calculated.

9. A communication apparatus comprising:
an antenna device,
the antenna device including:
a magnetic body; and
a coil of conducting wire wound around the magnetic body; and
a communicator coupled to the antenna device to communicate with an external device,
the antenna device having an inductance held within a predetermined range by adjustment of certain predetermined parameters based on a magnetic permeability of the magnetic body,
the predetermined parameters determining the inductance and relating to at least one of the magnetic body and the conducting wire.

10. A method for producing an antenna device, the method comprising:
a process of generating a magnetic body;
a process of measuring a magnetic permeability of the magnetic body;
a process of adjusting certain predetermined parameters based on the magnetic permeability of the magnetic body thus measured to hold an inductance of the antenna device within a predetermined range, the predetermined parameters determining the inductance and relating to at least one of the magnetic body and a conducting wire; and
a process of winding the conducting wire around the magnetic body.
